(19) United States
(12) Patent Application Publication
(10) Pub. No.: US 2017/0032418 A1
(43) Pub. Date: Feb. 2, 2017

(54) CUSTOMIZED VARIABLE CONTENT MARKETING DISTRIBUTION

(71) Applicant: R.R. Donnelley & Sons Company, Chicago, IL (US)

(72) Inventors: Greg Niesen, Prior Lake, MN (US); Scott Harvey, Naperville, IL (US); Jim Taraszka, Hawthorn Woods, IL (US); Douglas Swager, Mundelein, IL (US)

(21) Appl. No.: 15/212,003

(22) Filed: Jul. 15, 2016

Related U.S. Application Data
(60) Provisional application No. 62/197,445, filed on Jul. 27, 2015.

(51) Int. Cl. G06Q 30/02

(52) U.S. Cl. CPC G06Q 30/0259; G06Q 30/0269; G06Q 30/0255; G06Q 30/0252

(57) ABSTRACT

Customized variable content marketing distribution is disclosed. One disclosed example method includes defining a retail zone based on a location of one or more retail stores, identifying a plurality of subjects to be advertised, selecting a subset of consumers within the retail zone based on consumer data, and generating variable content advertising for the subset of consumers based on the consumer data and the plurality of subjects to be advertised. The example method also includes printing a segmented advertisement brochure based on the generated variable content advertising, where the advertisement brochure includes a plurality of segment portions, where a first segment portion of the plurality of segment portions includes a first subject of the plurality of subjects to be advertised and a second segment portion of the plurality of segment portions includes a second subject of the plurality of subjects to be advertised, and where the second subject is distinct from the first subject.

### RELATED APPLICATION

This application claims the benefit under 35 U.S.C. §119(e) to U.S. Provisional Application 62/197,445 titled “CUSTOMIZED VARIABLE CONTENT MARKETING DISTRIBUTION,” filed Jul. 27, 2015, which is incorporated herein by this reference in its entirety.

### FIELD OF THE DISCLOSURE

This disclosure relates generally to marketing distribution and, more particularly, to customized variable content marketing distribution.

### BACKGROUND

Known approaches for advertising to consumers include direct mail marketing campaigns. Typically, advertisers such as retailers rely on advertising materials, which may include flyers (e.g., direct mail advertising flyers, shared mail, etc.), that are sent to the consumers via a postal service to attract these consumers to retail stores. Often, the content of the advertising materials is generated based on generalized overall demographics of consumers within defined areas/regions and/or national demographic patterns.

Because the direct mail advertising content is not generally customized or tailored to each individual consumer or consumer subgroups, the recipients of these advertising materials often dismiss the advertising materials as mass-mailings (e.g., junk mail) and/or generally disregard the advertising content as irrelevant due to the seemingly random or overly broad nature of the advertisements presented in the advertising materials. Additionally, sometimes regions for the direct mail marketing campaigns are arbitrarily defined and, thus, may result in low response rates (e.g., rates at which the consumers respond to the advertising) due to perceived irrelevance by consumers.

These known marketing campaigns often result in an un-focused approach that is not tailored to shopping behaviors of consumers or consumer subgroups of these defined areas, thereby resulting in inefficient advertising and/or less efficient use of advertising budgets due to the low response rates resulting in lack of campaign profitability and decreased usage of direct mail as an advertising vehicle.

### BRIEF DESCRIPTION OF THE DRAWINGS

FIG. 1 illustrates an example customized variable content marketing distribution system in accordance with the teachings of this disclosure.

FIG. 2A illustrates an example region in which example retail zones may be selected.

FIG. 2B illustrates an example retail zone of the example region of FIG. 2A.

FIG. 3 is a detailed view of the example retail zone of FIG. 2B.

FIG. 4A illustrates an example seasonal data table that may be used to generate the examples disclosed herein.

FIG. 4B illustrates an example consumer shopping behavior survey data table that may be used to generate the examples disclosed herein.

FIG. 5A illustrates example custom variable content advertising generated using the teachings of this disclosure.

FIG. 5B illustrates another view of the example custom variable content advertising of FIG. 5A.

FIG. 6 illustrates yet another view of the example custom variable content advertising of FIGS. 5A and 5B shown in an expanded state.

FIG. 7 illustrates a schematic representation of an example system that may be used to implement the examples disclosed herein.

FIG. 8 is an example method in accordance with the teachings of this disclosure.

FIG. 9 is a schematic illustration of example processor platform to implement the example method of FIG. 8.

The figures are not to scale. Wherever possible, the same reference numbers will be used throughout the drawing(s) and accompanying written description to refer to the same or like parts.

### DETAILED DESCRIPTION

Customized variable marketing distribution is disclosed herein. Some marketing campaigns, in which retailers seek to gain or retain customers, include mass-mailing advertising campaigns. These advertising campaigns often involve direct mailings (e.g., bulk advertisement mailings) to areas and/or marketing regions. Even though the direct mailing content is sometimes generated based on aggregate demographics of consumers within defined areas/regions or national geographic trends/patterns, often this direct mailing content is ignored because of the perceived lack of relevance from a consumer perspective because content of these direct mailings is not generally focused to each individual consumer or consumer subgroups.

To reduce associated expenses with producing direct advertising mailings, the direct mailings may combine numerous advertisers (e.g., fifteen, sixty, etc.) into a single bulk mailing to lower overall advertising costs. However, the advertising or consumer response effectiveness, which is often measured or quantified in response rates of direct mailings with a high number of advertisers is often low because the recipient consumers (e.g., potential customers) may be overwhelmed by a seemingly indiscriminate collection of advertisements, which may sometimes appear completely unrelated, and/or not deem the advertising content to be relevant to their buying/shopping preferences and, thus, may dismiss (e.g., throw away) direct mailing content. Such a tendency to dismiss the advertising content often leads to lower advertising effectiveness and/or lower demand from advertisers for these direct mailings, thereby actually increasing overall advertising costs. In other words, low response rates of bulk mailings may, in fact, actually drive up advertising costs because the advertisers may have to engage in multiple mailings or secondary advertising campaigns to achieve the same or an equivalent response rate of a more effective campaign.

The examples disclosed herein allow specifically targeted consumer-focused and customized advertising content that is generated in a manner to significantly improve the effectiveness of advertising (e.g., improved overall response rates) and, thus, reduce overall costs associated with the advertising content by allowing advertisers to purchase fewer, more effective mailings. The examples disclosed herein enable region-focused and demographic-focused customized marketing content to significantly improve advertising efficiency and overall response rates of the advertising content. In some examples, the customized marketing content is also seasonally-focused and/or seasonally-timed. The examples disclosed herein enable generation of effective customized marketing content for individual consumers and/or focused consumer subsets (e.g., subgroups, demographic subsets) based on an effective advertising region definition and a targeted consumer subset of consumers of the defined region.

In accordance with the teachings of this disclosure, a retail zone is defined based on a location of one or more retail stores or chain of stores. Relevant products or retailers within or proximate the retail zone are identified. A subset (e.g., a demographic subset, a subset including multiple demographic categories) of consumers within the retail zone is identified or selected (e.g., selected from an overall consumer list of the retail zone) based on, for example, consumer shopping behavior data. In some examples the consumer behavior data may include one or more of survey data, census data, loyalty data, shopping preferences and/or demographic data. In some examples, the selected subset of consumers may have demographic characteristics associated with high consumer shopping confidence indexes in regards to the identified products or retailers. In some examples, the identified retailers may be taken into account when selecting consumer subsets. In other examples, the identified relevant products or retailers may be selected or defined based on the selected consumer subset. Variable content advertising is generated for each consumer or a subgroup of consumers of the selected subset based on the retail zone, the selected consumer subset and/or the identified relevant products/retailers.

In some examples, relevant retail categories, the subset of consumers, the retail zone and/or the identified relevant products and/or retailers are at least partially based on seasonal timing. In some examples, the subset of consumers are identified/selected by consumer survey data (e.g., polling data, polling demographics, survey data provided automatically, consumer data compiled and/or developed by third party researchers, etc.) in combination with loyalty program membership. In some examples, the generated variable content advertising is transmitted to a printer or printer location for production and/or distribution (e.g., mail distribution). In some examples, one or more of the retail zone, the subset of consumers, and/or the identified relevant retailers and/or products are reiteratively adjusted (e.g., based on reiteratively evaluating an overall predicted response index) to increase an overall advertising response rate of a specific custom generated advertising mailing.

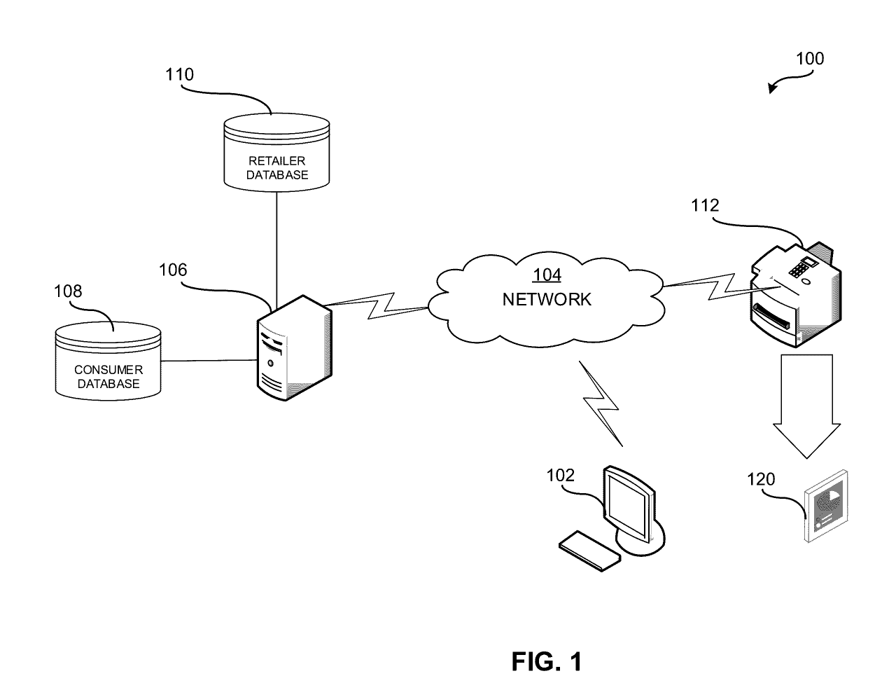

FIG. 1 illustrates an example customized variable content marketing distribution system 100, in accordance with the teachings of this disclosure. The example marketing distribution system 100 includes an example terminal 102, an example network (e.g., a telecommunications network, a local area network (LAN), an IP-based network, etc.) 104, and an example database server 106, which is communicatively coupled to the network 104 that includes consumer and retailer databases 108 and 110, respectively. In this example, the network 104 is also communicatively coupled to a printer and/or printing production system 112. In some examples, the printer and/or printing production system 112 is part of a mailing distribution/production facility.

In the illustrated example of FIG. 1, the terminal 102 interfaces with the database server 106 via the network 104 to generate customized advertising content/materials. For example, the terminal 102 interfaces with the database server 106 to access the retailer database 110 to retrieve retailer information, product information, geographical information of retail stores and/or seasonal information, etc. In this example, the terminal 102 also interfaces with the database server 106 to access the consumer database 108 to retrieve consumer lists (e.g., consumer address data), consumer data (e.g., consumer behavior data, survey data, consumer behavior data correlated to the consumer lists), demographic data, customer loyalty data and/or seasonal information (e.g., seasonal consumer or retail data, which includes what type(s) of consumers purchase what type(s) of products at specific times of the year).

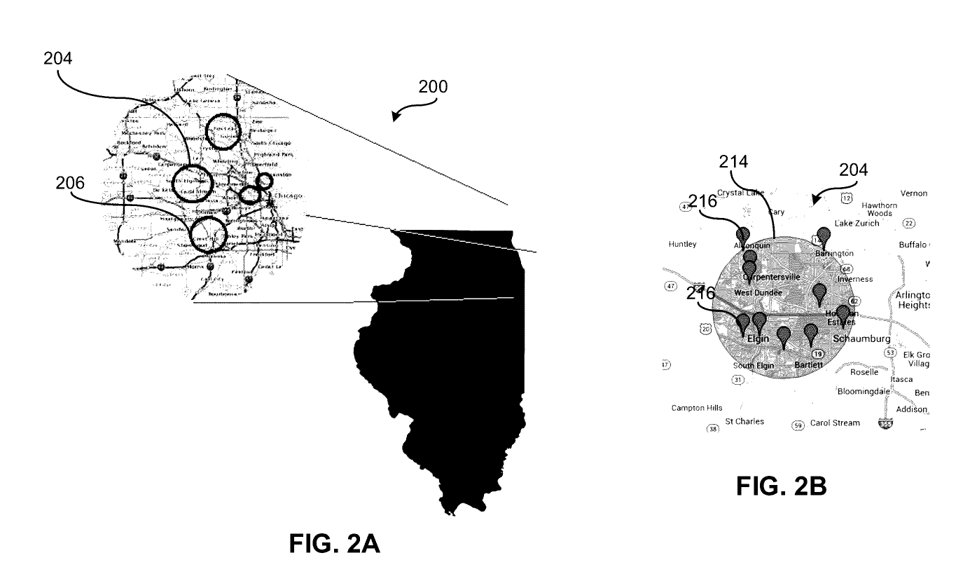

In this example, through accessing the databases 108, 110, the terminal 102 of the illustrated example utilizes retrieved data from the retailer database 110 to define a position (e.g., a centering position) and/or size of a retail zone (e.g., a focused retail area). This determination of the position and/or size of the retail zone will be discussed in greater detail below in connection with FIGS. 2-8. In some examples, the terminal 102 determines or defines the retail zones based on seasonal data and/or identified relevant retailers/products. In this example, the terminal 102 determines or selects a subset of consumers within the defined retail zone based on consumer data (e.g., selects consumer demographic data, survey data, survey data that identifies favorable demographic categories, etc.) accessed from of the consumer database 108.

In this example, the terminal 102 defines and/or generates focused and/or customized advertising content for the selected subset of consumers based on consumer behavior data and/or identified retailers using retail categories, for example. In some examples, seasonal data is used to define the retail categories and/or relevant retailers/products. In some examples, the subset of consumers is selected based on a consumer shopping confidence index related to specific demographic categories (e.g., ages 25-44 with children, etc.). In particular, consumers with demographic characteristics associated with the highest consumer shopping indexes for certain corresponding retail categories, retailers and/or products may be selected to define the subset of consumers. In some examples, relevant retail categories, which are based on seasonal data, are used to select the relevant product/retailers, which are then used to determine the subset of consumers based on the highest consumer confident index. Conversely, in some examples, the retailers and/or retail categories are selected based on a previously selected/determined subset of consumers (e.g., consumers with the highest consumer confidence index).

In some examples, once the terminal 102 of the illustrated example has generated customized advertising content, the terminal 102 transmits the customized advertising content along with a portion (e.g., a subset, targeted recipients) of the consumer database 108, which may include or be associated with versions (e.g., consumer demographic data labels that correspond to the consumer database 108), to the printer 112. In some examples, transmitting this portion of the consumer database 108 allows this portion to receive properly customized content. The printer 112 produces a custom (e.g., customized and/or individualized for targeted recipient(s)) advertising flyer 120, which is to be sent via mail to a consumer via a distribution channel, for example. In some examples, identifying and transmitting the portion of the consumer database 108 includes identifying specific recipients with specific interests for more highly individualized versions. In some examples, the advertising flyer 120 is customized (e.g., customized text and/or graphics) to a specific consumer and/or household of the selected consumer subset. Alternatively, in other examples, the flyer 120 is customized to a specific subset or group of consumers (e.g., members of a retail loyalty program, etc.) of the selected consumer subset.

FIG. 2A illustrates an example region 200 in which retail advertising zones (e.g., retail zones, retail activity zones, trade zones, etc.) may be selected and/or defined. The example region 200 includes a state, a city, a suburb, a metropolitan area, a grouping of cities or towns, etc. that includes multiple retail zones (e.g., retail regions, retail area segments) 204, 206. The definition and/or selection of the retail zones 204, 206 will be described in greater detail below in connection with FIG. 2B. The retail zones 204, 206 of the illustrated example define areas that may be used to focus marketing campaigns by targeting specific consumers and/or groups of consumers within their respective retail zones, for example.

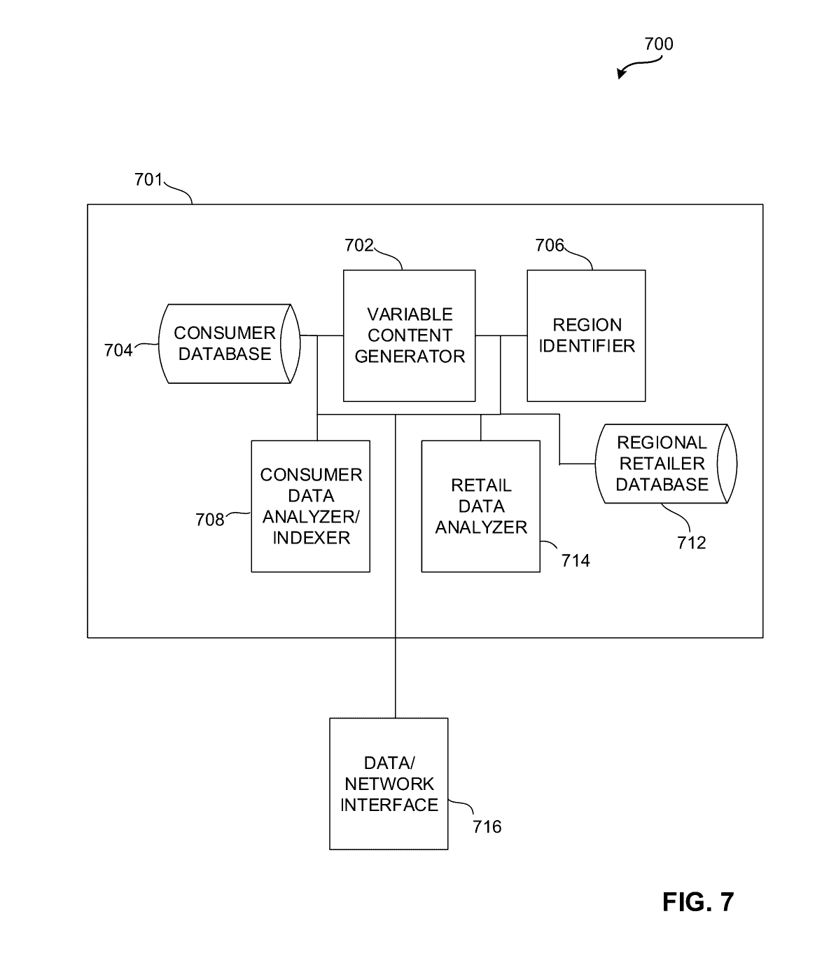

FIG. 2B is an enlarged view of one of the example retail zones 204 of FIG. 2A. The example retail zone 204, which may be defined by a region identifier such as a region identifier 706 described below in connection with FIG. 7, of the illustrated example includes a defined area 214 that may be based on positions and/or relative positions of one or more retail stores 216. The positional data used to define the extent and boundaries of the area 214 may be based on map data including, for example, internet map data, web-based mapping services, and/or other automatically retrievable data). In some examples, the example zone 204 is centered on one of the retail stores 216. In other examples, the example zone 204 is centered based on more than one of the retail stores 216 (e.g., centered between, weighted centering based on relative positions of the retail stores 216 to one another, etc.). In some examples, multiple stores (e.g., stores of the same or different retail chains, a spatial relationship of stores of the same or different retail chains, etc.) are used to define a location (e.g., a centering position) of the retail zone 204. In particular, a zone may be positioned based on a combination of stores of two or more retail chains (e.g., a zone centered on a pair of retail stores of different retail chains, a zone defined by an approximate spatial relationship between retail store X and retail store Y, etc.).

For example, a processor of the terminal 102 of FIG. 1 may download map data (e.g., Google maps) that includes locations of retail stores. The processor may search the map data for retail patterns. For example, the processor may search for instances of a Best Buy® retail store within 2 miles of a Target® retail store. The processor of such an example may find one or more locations containing such a spatial pattern and position a center of a retail zone based on the occurrence of the spatial pattern.

In some examples, the retail zone 204 is defined (e.g., shaped, positioned and/or sized) to encompass a certain number of stores (e.g., stores of the same retail chain, stores of different retail chains, a minimum number of retail stores of one or more retail chains, etc.). In some examples, the size of the retail zone 204 is based on a time to travel and/or travel distance to another retail zone (e.g., an adjacent retail zone).

The size of the retail zone 204 (e.g., a radius, a diameter, and/or any other dimensional value including a sum area, etc.) may be based on consumer data, population data, population density, product characteristics, product relevance and/or retailer information. Additionally or alternatively, the size of the retail zone 204 may be based on seasonal factors (e.g., time of the year, holidays, etc.) and/or consumer behavior (e.g., consumer behavior models, consumer behavior data, etc.). In some examples, the size of the retail zone 204 is based on a population threshold encompassed within a zone (e.g., the size of the retail zone 204 is increased or decreased until a population within the retail zone 204 meets a pre-defined population criteria or range). Additionally or alternatively, the size may be set to a specific radius (such as, for example, 5 to 11 miles or other suitable values). In some examples, definition of the retail zone 204 is based on a general presence and/or a number of retail stores and/or retail store clusters (e.g., sized to encompass a certain number of retail stores and/or patterns of retail stores), which may be of the same or different retail chains. Additionally or alternatively, a zone is at least partially defined by a “heat map” of retail stores. In some examples, a retail zone is defined by 85-90 prevalent retail stores (e.g., retail stores that exceed a defined revenue, retail store chains that exceed a defined number of stores, etc.), which may be of the same or different retail chains. In some examples, a retail zone is defined by postal codes.

While the retail zone 204 of the illustrated example is shown as a circular-shaped zone, other shapes also may be used, including, but not limited to, rectangular shapes, triangular shapes, polygonal shapes, asymmetric shapes, irregular shapes, or any other appropriate or desired shapes. Additionally or alternatively, the zone 204 may have a non-contiguous shape to encompass certain specific population demographics and/or to focus on specifically defined areas of the zone 204 surrounding the retail stores 216, for example.

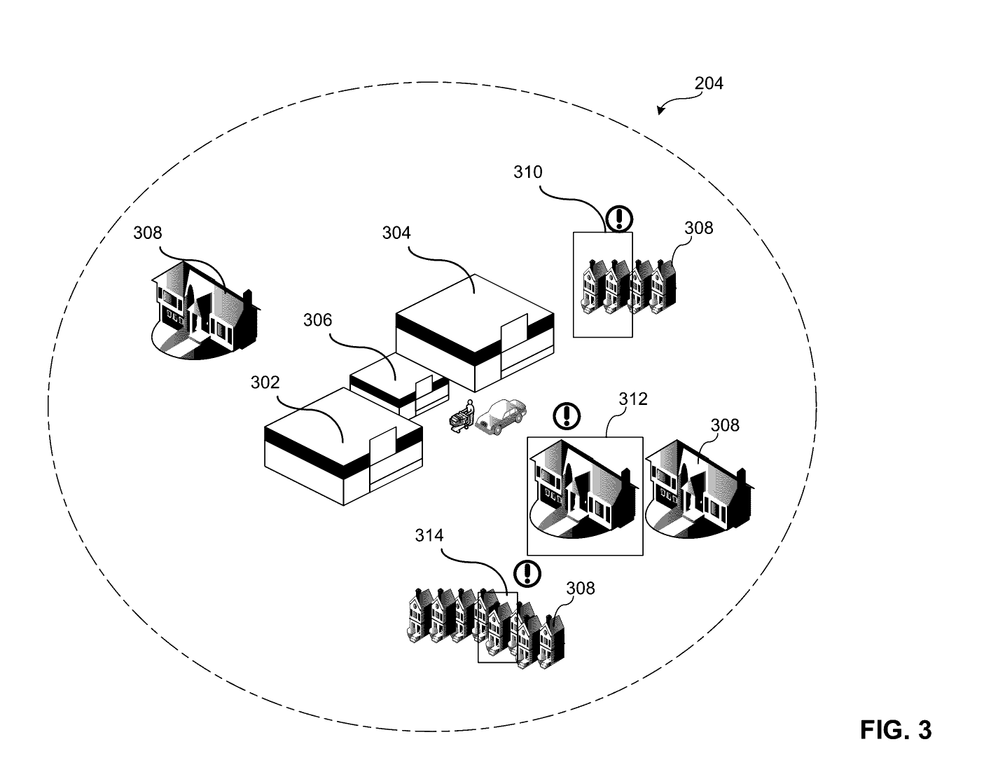

FIG. 3 is a detailed view of the example retail zone 204 of FIG. 2B. In the view of FIG. 3, the example retail zone 204 includes retail stores 302, 304, 306 and numerous households 308 located throughout the retail zone 204. In this example, the retail zone 204 is centered relative to the retail store 306 (e.g., an anchor store). In other examples, the retail zone 204 may be generally positioned relative to or centered based on all or a portion of the retail stores 302, 304, 306. In this example, defining the retail zone 204 based on retail stores allows selection of households that are on convenient and frequent travel routes, thereby increasing a probability of a response to the advertising. Generally, retail stores and/or a critical mass of retail stores often indicate significant retail commerce, which is beneficial in selecting a position of a retail zone.

In this example, potential retailers and/or products to be advertised in the generated advertising content are determined or selected by a retail data analyzer such as a retail data analyzer 714 described below in connection with FIG. 7. The retailers and/or products are incorporated into the generated advertising content when the retailers and/or products are determined to be relevant (e.g., relevant to a current or upcoming season, relevant to the shopping preferences of consumers of certain demographic categories, etc.). In some examples, potential retailers and/or products are deemed relevant for incorporation onto marketing content by consumer demographic data, which may specifically pertain to the retailers (e.g., retailers who have a significant amount of loyalty card memberships in the retail zone 204). In some examples, the retailers or products are selected based on a determined subset of consumers. In some examples, the retailers and/or products are selected based on seasonal factors (e.g., office supply stores and/or clothing stores for late summer when stores typically have back-to-school promotions, etc.).

In some examples, not more than one retailer in a retail category (e.g., sporting goods, clothing, electronics, household items, etc.) is selected to be on a single generated advertising piece to avoid inclusion of retail products from similar markets and/or similar types of retail stores. In other words, competing retail stores (e.g., retail stores competing in the same or similar categories of products or services) of the illustrated example are not included in the same generated advertising content to avoid potential conflicts. While competing advertisers may be approached/offered for inclusion into the advertising content, in this example, only one of the advertisers of a certain category is selected for inclusion.

In some examples, the retailers deemed relevant for incorporation are requested to provide advertising that is pertinent to a current season or to revise their advertising to avoid being removed from the advertising content.

In this example, a subset of consumers and/or select households of the household 308 are defined by a consumer data analyzer/indexer 708 of FIG. 7 to narrow or select recipients to receive the generated advertising/marketing content, thereby increasing advertising efficiency and/or consumer response rate by avoiding the mailing of advertisements to recipients who have a reduced probability of conducting business with the advertisers. In particular, the consumer data analyzer/indexer 708 of the illustrated example selects a subset that includes households 310, 312, 314 and/or specific consumers of the selected households 310, 312, 314 to receive custom variable generated marketing content. For example, the selected subset may be at least partially defined by demographics linked to consumer patterns and/or behavior that are indicated by consumer survey data, for example. In particular, the subset may have consumers that match demographic characteristics associated with a high predicted response rate (e.g., a high consumer shopping confidence index).

In some examples, the subset of consumers is at least partially defined by loyalty program membership (e.g., as identified by the advertiser), consumer behavior patterns, consumer behavior data, survey results, US census data, specific purchases and/or demographic data. In some examples, the subset of consumers is at least partially selected or defined based on a selected group of retailers (e.g., a group of selected retailers from the defined retail zone). In some examples, the subset of consumers is at least partially defined by seasonal factors (e.g., whether certain demographic groups purchase skiing gear during the winter, etc.).

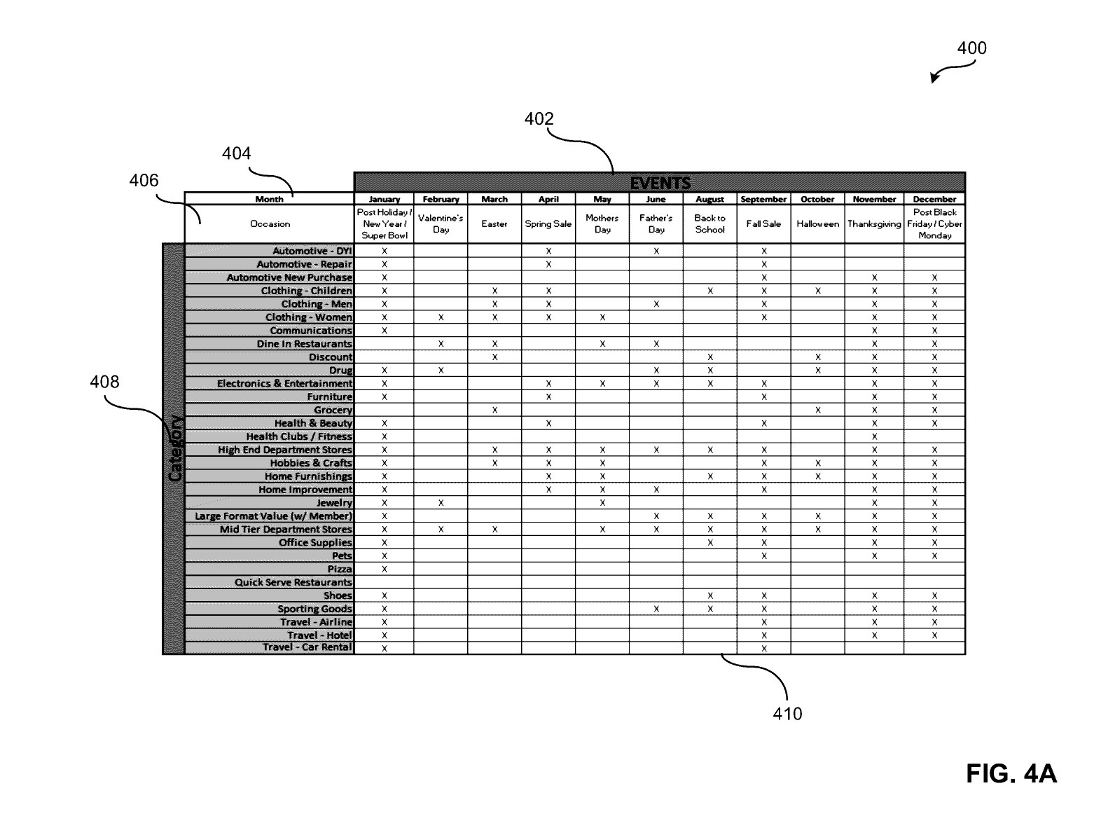

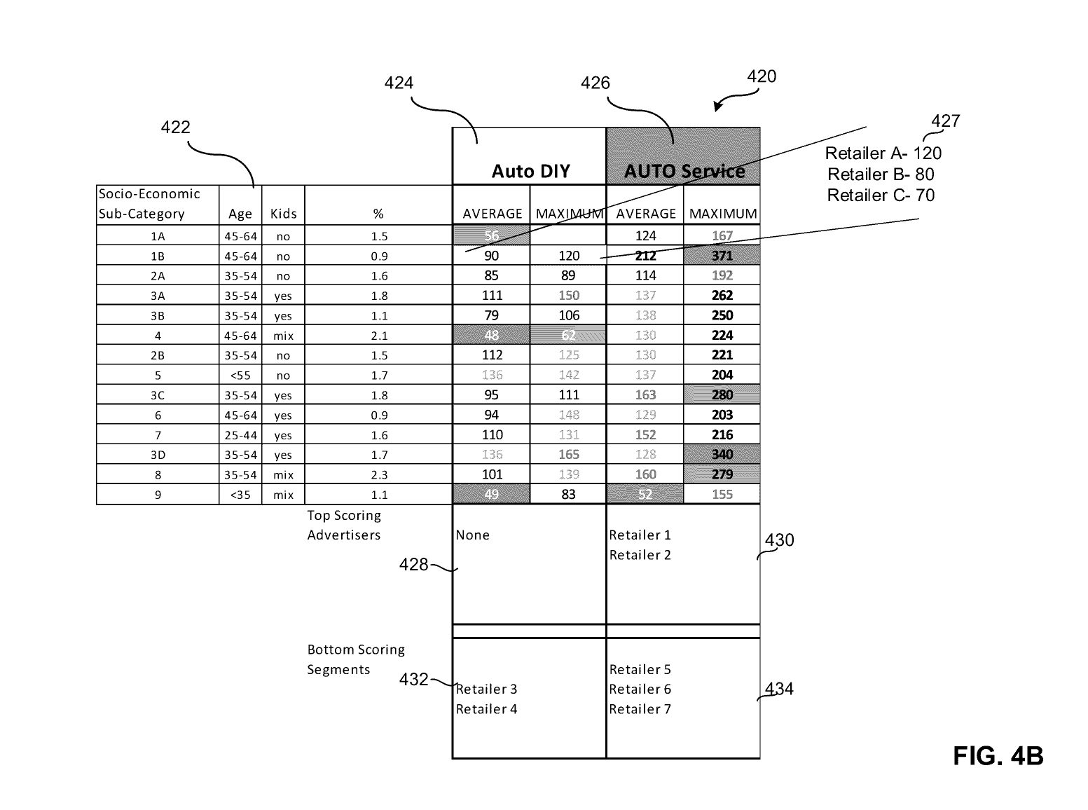

FIG. 4A illustrates an example seasonal data table 400 that may be used to generate the examples disclosed herein. The seasonal data table 400 of the illustrated example relates different times/seasons of the year to consumer interest and/or increased consumer demand for certain retail categories and/or retail stores. The seasonal data table 400 includes seasonal events 402, which is sub-divided into months 404 and yearly occasions (e.g., holidays) 406, and retail categories 408. A central portion 410 of the seasonal data table 400 indicates increased consumer interest in the retail categories 408 during different times of the year.

As can be seen in the seasonal data table 400, groups of different retail categories show increased consumer interest at different times of the year. For example, increased interest in clothing for children and office supplies occurs in August as families prepare to send their children back to school. The example seasonal data table 400 may be used to make an initial selection of retail categories and/or retailers to be offered to be advertised on the focused marketing content at a specific time of year. Additionally or alternatively, the example seasonal data table 400 may be used to select or define a retail zone (e.g., a retail zone is at least partially selected and/or defined based on seasonal effects of the retail zone and/or seasonal effects observed on a national scale). For example, a zone may be defined for an August mailer based on the number of clothing and office supply stores in an area. The zone may be defined so that a first Office Depot® store includes a first subset of households in an area, and a second Office Depot® store includes a second subset of households. Different zones may be defined for a November mailer based on the locations of grocery stores to focus on Thanksgiving purchases. If an area has more grocery stores than office supply stores, the zones for the August mailer may be larger and less numerous than the zones for the November mailer.

FIG. 4B illustrates an example consumer shopping behavior data table 420 that may be used to generate the examples disclosed herein. The consumer data table 420 of the illustrated example relates consumer demographic data to retail stores identified by product categories to predict consumer responsiveness (e.g., response rates) with respect to consumer survey data expressing shopping behavior which is then overlaid with demographic attributes. The consumer demographic data, which may be derived from consumer survey data, is used to select subsets of consumers within defined retail zones. In particular, the consumer demographic data may be used to identify consumers and/or households of the retail zone that are within favorable demographic groups/categories because they are more likely to respond to advertising related to selected retailers and/or retail categories.

The surveys used to generate data tables such as the data table 420 may utilize national data and/or data derived from local or other regions. In some examples, households within the retail zone and even households outside a defined trade zone may be analyzed in conjunction with demographic information (e.g., census data) as well as information collected and sold by third party organizations.

The survey data, in some examples, includes past and future shopping behavior from statistically valid national panels. In some examples, the survey panels and households are referenced or normalized against a standardized segment of national households. Subsets of households may be determined using industry accepted household demographics categories such as income, age, home ownership, education and family composition by comparing household data (e.g., retail zone household data, regional household data, household composition) to identified demographic categories of surveys. Survey information may be collected (e.g., subscribed to) from third-party survey companies. In some examples, respondents are asked about past and future shopping behavior related to product categories, specific products and specific retailers. Respondents to the surveys may be tracked by household and their respective households may be categorized based on demographic makeup and the categorizations may be recorded/stored (e.g., for later use/analysis).

The aforementioned response scores/consumer confidence shopping indexes may be established for each product category based on an analysis of shopping behavior of each demographic segment by relating survey information to population percentages of demographic categories of respondents of each survey. For example, the consumer shopping confidence index may be defined as an average or weighted score of a group of similar questions related to a product category which may include specific named retailers of such products. In some examples, the consumer shopping confidence index may be determined by weighting numerous factors.

The consumer data table 420 includes a demographic section 422, which shows a small portion of all consumer categories, response scores for a first retail category (e.g., auto DIY) 424, response scores (e.g., consumer shopping confidence indexes based on survey data) for a second retail category (e.g., auto service) 426, top retailers for the first retail category 428, and top retailers for the second retail category 428. The response scores of the first retail category 424 and the second retail category 426, which are also known as consumer shopping confidence index numbers, may be scaled appropriately to numerically indicate predicted consumer interest of demographic subsets and may be based on analyzing portions (e.g., parsing and/or querying portions) of consumer survey data, which encompasses a wide range of topics and/or consumer categories. The first and second retail categories 424, 426 include embedded retailer data (e.g., consumer shopping confidence indexes corresponding to specific retailers) 427. The top retailers for their respective categories 428, 430 of the illustrated example are determined based on this embedded retailer data 427, which indicates higher consumer shopping confidence indexes in relation to specific demographic categories of the demographic section 422, for example.

The example demographic section 422 includes household consumer data determined nationally (e.g., aggregate household data taken on a national scale) or within a specific region (such as, e.g., the defined retail zone or another region). The demographic section 422 of the illustrated example includes demographic subsets categorized and/or sub-divided by socio-economic sub-categories (e.g., education, income, etc.) age ranges, whether the household has children, and demographic percentages of the population of the selected area and/or defined retail zone. In this example, the percentages in the demographic categories 422 correspond to percentages of the demographic categories and/or an overall demographic composition of consumers within the defined retail zone. In other examples, the percentages of the demographic categories 422 indicate national population percentages or a demographic composition of consumers that participated in a consumer survey. Also, in some examples, other demographic metrics may be used additionally or alternatively such as, for example, income, education level, occupation, etc.

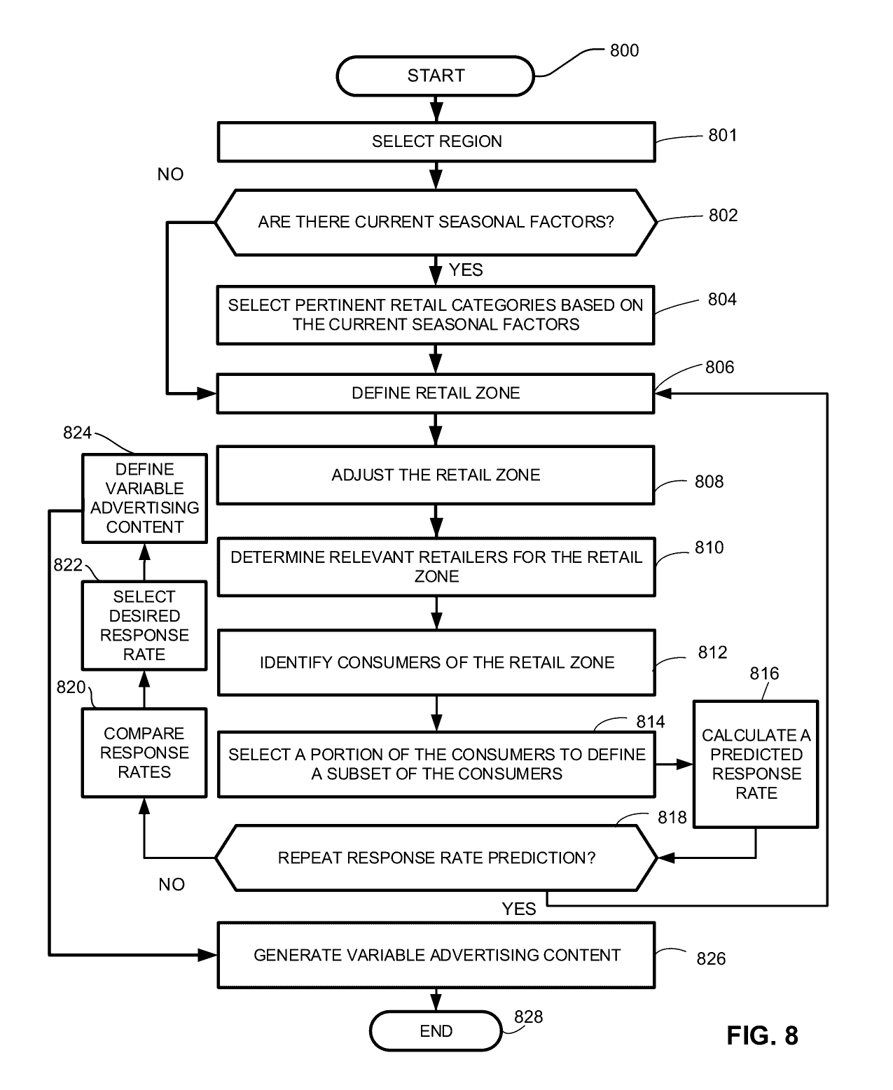

In this example, the quantified data shown in the table 420 is used to select consumer subsets from an overall list of consumers (e.g., select consumers matching and/or exhibiting characteristics of favorable demographic categories indicated by the table 420) within a defined retail zone to receive the custom generated advertising content based on an average consumer shopping confidence index (e.g., an average of numerous retailers instead of a single maximum consumer shopping confidence index pertaining to consumer behavior survey and, in some examples, could include a retailer). The response scores (e.g., consumer shopping confidence index scores) of different demographic groups/categories are quantified into numerical scores and organized into categories to more effectively select consumers and/or households of the retail zone corresponding to favorable demographic categories. This selection of the consumer subset allows favorable recipients (e.g., recipients more likely to respond) of the customized marketing content to be identified. In some examples, the demographic subsets, which may include one or more demographic categories, are selected based on the average consumer shopping confidence index exceeding a pre-defined threshold index value after retailers and/or retail categories have been identified. In other examples, the maximum consumer shopping confidence indexes referenced from survey data are used instead of the average consumer shopping confidence indexes to select the demographic subsets to receive the advertising materials, and/or the retailers are also identified based on these maximum consumer shopping confidence indexes. Alternatively, selection of consumers and retailers/products may be done together (e.g., the highest response scores are selected regardless of retailer/product categories). As will be described in greater detail below in connection with FIGS. 7 and 8, a retail zone definition, a subset of consumers and/or selected retailers/products may be reiteratively adjusted to increase a predicted response score (e.g., consumer shopping confidence index value(s)).

The response scores/consumer shopping confidence indexes may be based at least partially on a defined retail zone and/or adjusted based on the retail zone (e.g., adjusted based on data pertaining to the retail zone such as local surveys or local consumer behavior, etc.). In some examples, the surveys to determine consumer confidence indexes include questions that cover different topics germane to different retailers, retail categories, seasons and/or product offerings. The total number of survey questions to cover all topics across all categories and demographics may be hundreds (e.g., 850), but only a portion would be presented to a consumer fitting specific demographics in relation to retailers/product categories. In some examples, the questions may also include questions about a retailer's online presence.

The first category 424 has average response scores (e.g., consumer shopping confidence index values), which are based on survey data, for the specific demographic groups as well as the highest response score of retailers in the first category 424. Likewise, the second category 426 has average and highest response scores for retailers in the second category 426. In some examples, an average response score of an entire demographic group (e.g., age 25-44 with kids) may have a lower response score with a first retailer, but a relatively higher response score with a second retailer of the same category, for example. In some examples, response score thresholds (e.g., consumer shopping confidence index thresholds) are used to determine whether the demographic groups should receive the customized marketing content from specific retailers.

In this example, the selected top retailers 428, 430 are designated as retailers selected using the embedded retail data 427 and based on their respective response score categories 424, 426 derived from consumer behavior models/data such as a higher responsiveness of the group of selected consumers/households (e.g., a high response score/consumer shopping confidence index) and/or a predicted degree to which the subset of selected consumers, which may include a single or multiple demographic subsets, is likely to respond to advertising. In this example, none of the retailers of the first category 424 has a predicted response score higher than a threshold (e.g., 160) and, thus, no retailers of the first category 424 are selected for the top retailer 428. In this example, for a demographic category of age ranges 35-54 with kids that composes 1.1% of the population, all the retailers in the first category 424 average a consumer shopping confidence index of 111 while a retailer in the first category 424, Pep Boys® has the maximum consumer shipping confidence index of 150 for that specific demographic category. However, AutoZone®, which is another retailer of the first category 424, has a consumer shopping confidence index of 120 for the same demographic category.

In contrast, the second category 426 of the illustrated example has two retailers in the top retailers 430 that exceed a threshold for the second category 426 (e.g., 300). In this example, the thresholds vary between categories and the highest consumer shopping confidence indexes that exceed a threshold are selected as top advertisers. In other examples, the thresholds may be identical between different categories. In some examples, the highest scoring retailers, regardless of exceeding any threshold, are selected.

In some examples, the top retailers 428, 430 are determined based on the demographic composition of the defined retail zone. In particular, population percentages of the demographic categories of the defined retail zone are taken into account, for example. In some examples, only a single retailer of a specific category of retailers is selected to be featured in an advertising offer. Alternatively, in some examples, a group of retailers of a specific category (e.g., the top retailers in each category) are offered an opportunity to advertise to the targeted subset of consumers within the defined retail zone. In some examples, the demographic factors may include income, age, home-ownership, education, occupation, etc., and may be taken into account in determining demographic consumer subset categories. In some examples, the demographic consumer categories may be rearranged, reorganized and/or re-categorized due to seasonal factors.

In some examples, bottom scoring demographic segments are determined for each retail category. In this example, a first bottom scoring segment list 432 is determined for the first category 424. Likewise, a second bottom scoring segment list 434 is determined for the second category 426. The bottom scoring segment lists 432, 434 describe demographic categories that are the least likely to respond to marketing content related to their respective product categories (e.g., demographic categories with the lowest average consumer shopping confidence indexes for the product categories) and may be used to segregate certain retailers (e.g., prevent generation or sending of marketing content on behalf of) based on the embedded retail data 427 for specific retailers that may have low response scores, even though a corresponding group of retailers may have an overall favorable response rate.

In some examples, consumer demographic data can be encoded/stored as labels, which are referred to as versions, for each household. In particular, these versions may be associated with households by being appended as demographic markers/labels to associate household demographic data with each household. For example, versions may label specific demographic characteristics of a consumer or a household as codes (e.g., characters, symbols, etc.). For example, a version with the letters “nc” may be added to a household as signifying no children.

Version codes can be used to tie/correlate creative content (e.g., files, images, text, etc.) with the versions and/or household demographic data, for example. In particular, the version codes may be symbols or metadata that tie the versions to specific advertising content that is likely to receive a higher response rate with the associated version. The association with the version codes may be determined using the examples disclosed herein such as the table 420. In some examples, the version codes can be used to drive the manufacturing process of custom advertising by indicating the consumer demographic data of each household and using the version codes to associate the creative content defined by the version code(s) for production. In some examples, retailers/advertisers may append additional codes and/or associate the version codes (e.g., newer version codes) to the household demographic data to associate more creative content and/or drive the manufacturing process.

In some examples, an “optimized inclusion” model is used to update and/or reinterpret consumer demographic data and/or consumer behavior models (e.g., consumer shopping confidence indexes, etc.) based on the highest scoring product categories and retailers by consumer segment. In some examples, purchases (e.g., specific purchases of individual products at individual retailers at certain times) and/or other consumer data may be utilized. In particular, retail sales of specific consumers of certain demographic categories may be analyzed to continuously update consumer shopping confidence indexes such as those shown in the table 420. Additionally or alternatively, retail data (e.g., seasonal economic trends) and/or data about relevant retailers or products may be continuously updated and/or reinterpreted as well. In some examples, this updating allows continuous reevaluation of advertising effectiveness to allow for even more focused custom generated advertising content. In some examples, this updated data is used to generate custom generated advertising to be sent to targeted consumers two to eight times per year, for example. Additionally or alternatively, specific consumers and/or households can be matched to retail stores in real-time based on a scoring process where the highest six consumer shopping confidence indexes are to be featured in six designated portions (e.g., advertising portions) of the custom generated advertising content, for example.

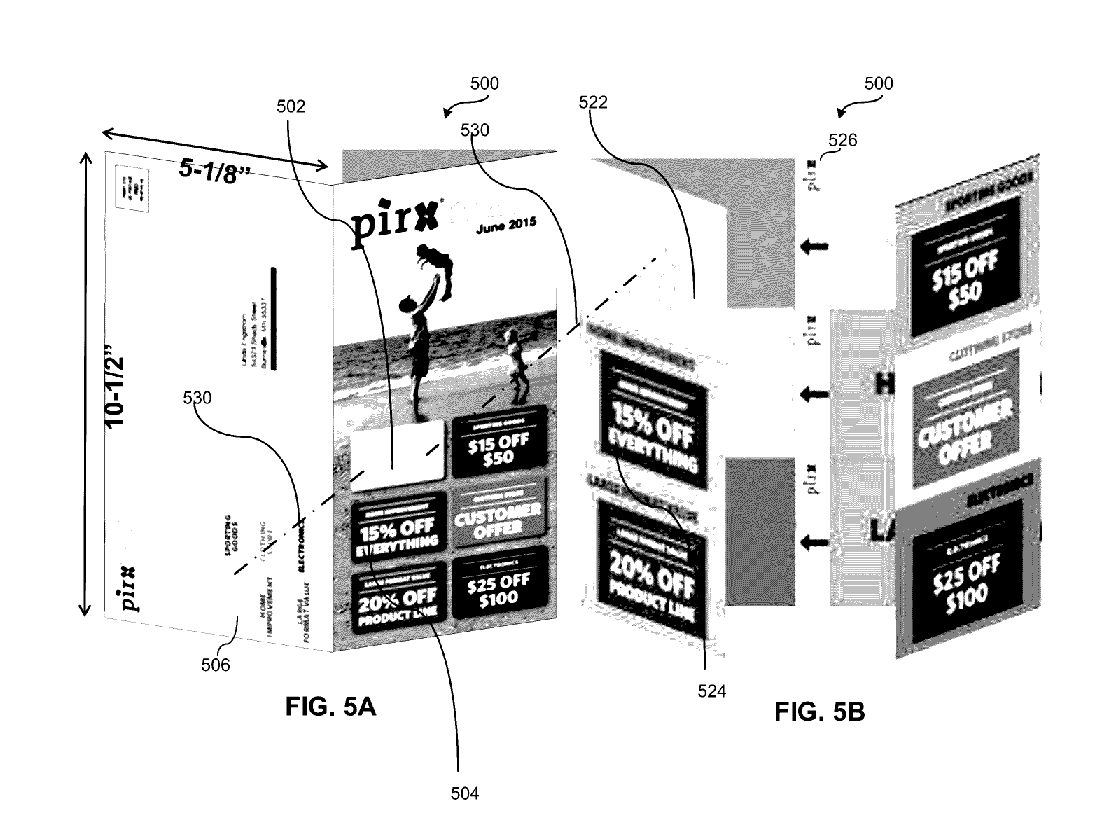

FIG. 5A illustrates example custom variable content advertising 500 generated using the teachings of this disclosure. The custom variable content advertising 500 of the illustrated example includes advertising portions or sections 502, 504, which are used by different retailers that have been selected to be featured in the variable advertising 500 via the examples disclosed herein. In this example, the advertising portions 502, 504 are printed in different colors and/or text to distinguish the different advertisers and/or advertising categories on the variable content advertising 500. In some examples, the selection of retailers and/or customized graphics/text of the advertising portions 502, 504 are customized (e.g., customized text, graphics and/or fonts) to individuals or consumer subsets. For example, a first consumer might receive custom variable content advertising with different retailers and/or categories in the advertising portions 502, 504 from a second consumer. Additionally or alternatively, messages in the variable content advertising 500 are tailored for a demographic category, in which the recipient is a part of the content (e.g., a message about back-to-school timing to households and/or consumers with multiple kids, etc.).

In some examples, the variable content advertising 500 includes preview category descriptions 506, which may describe potential categories included within the variable content advertising 500. In some examples, the category descriptions 506 are aesthetically coordinated with other corresponding portions of the same category.

Because the custom variable content advertising 500 is particular to individual consumers or consumer subgroups, the custom variable content advertising 500 focuses on relatively few advertisers (e.g., three to six instead of fifteen to sixty). In this example, the custom variable content advertising 500 features six different advertisers in six distinct retail categories (other examples may include other numbers of advertisers or advertisers in competing categories). Because of the relatively low number of advertisers, higher quality materials (e.g., die cut cutouts for coupons, etc.) may be used instead of the typical collection of papers to create a more compelling presentation to recipients and, thus, further increasing potential response rates which, in turn, lowers overall advertising expenses by reducing a print production volume typically necessary to receive an equivalent response rate. In this example, the example folded dimensions of the customized variable content advertising is approximately 10½″ inches (″) in length and 5⅛″ in height with a ½″ lip. In some examples, the custom variable content advertising 500 is an approximately four page self-mailer with approximately 50 inches squared of advertising space. These dimensions allow for the application of postal discounts. Other appropriate dimensions may also be used in other examples.

FIG. 5B illustrates another view of the example custom variable content advertising 500 of FIG. 5. In the view of FIG. 5B, separable and/or removable (e.g., tear out, fold out, etc.) portions (e.g., cards) 522, 524 are included with the custom variable advertising 500. In this example, the removable portions 522, 524 are distinguished by different indicia (e.g., colored differently, different typeset) to distinguish the different retail categories represented in the advertising portions 522, 524.

In this example, the removable portions 522, 524 are credit card sized (e.g., a relatively rigid construction) that may be removed by consumers via perforations surrounding the removable portions 522, 524 or by pulling against a releasable adhesive coupling the removable portions 522, 524 to a base substrate. In some examples, the removable portions 522, 524 have a unique code, which can be scanned by a consumer for offers and information, and to identify whether the consumer has scanned the unique code (e.g., for consumer behavior analysis and response rate data). In some examples, the custom variable content advertising 500 includes an interface portion 526, which may be separable. As can be seen by dotted lines 530 of FIGS. 5A and 5B, different portions of the custom generated advertising 500 may be coordinated and/or correlate with one another in other visual ways.

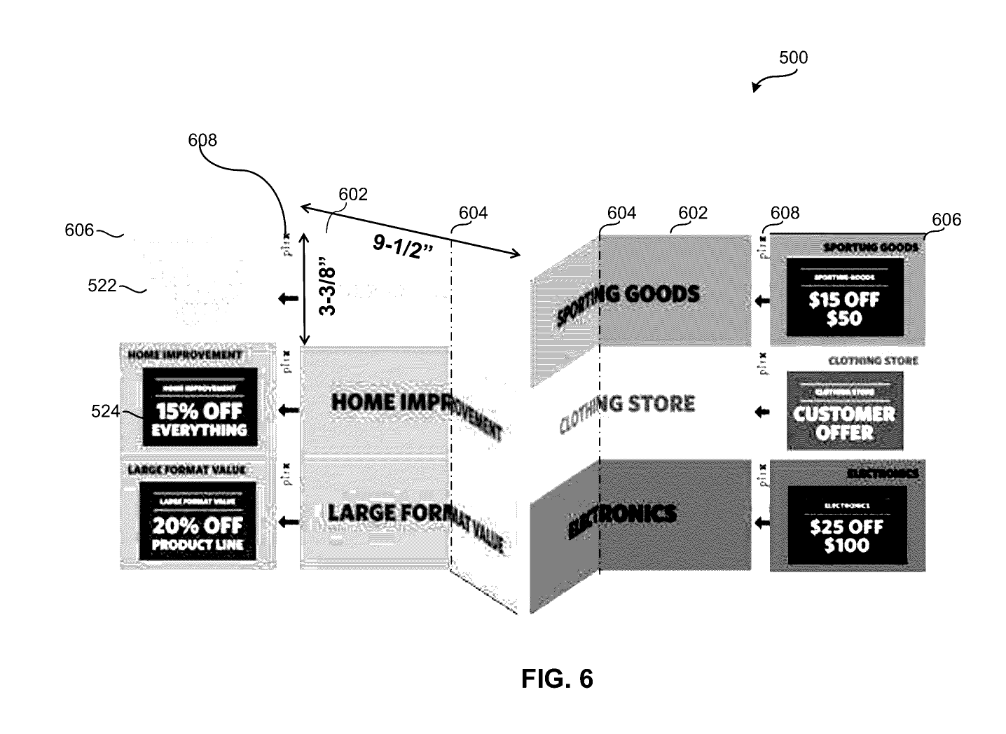

FIG. 6 is yet another view of the example custom variable content advertising 500 of FIGS. 5A and 5B shown in an expanded (e.g., unfolded) state. In the view of FIG. 6, middle advertising portions 602 are expandable at fold lines 604, and separated from offer portions (e.g., removable coupons) 606, which hold the removable portions 522, 524 and other removable portions, via the interface portions 608. In this example, each of the middle advertising portions are approximately 9½″ by 3⅜″ in the unfolded state.

The middle advertising portions 602 of the illustrated example provide additional space to supplement the offer portions 606 with additional content to attract consumers to the advertised retailers featured in the custom variable content advertising 500. The middle advertising portions 602 are also placed to correspond to their respective advertising offers. In some examples, the custom variable content advertising 500 includes a link, a QR code, bar code and/or any other appropriate indicator to provide a consumer with augmented reality embedded onto a display or other graphics used by the consumer. For example, a consumer may scan a code and then access, via a tablet or smart phone, supplemental content including additional brand, product information, text, offers, etc. without using additional advertising space on the custom variable content advertising 500. In some examples, instances and/or whether a consumer accesses the supplemental content are used to update consumer behavior data (e.g., consumer confidence shopping indexes).

FIG. 7 illustrates a schematic representation of an example custom advertising generation system 700 that may be used to implement the examples disclosed herein. The example advertising content generation system 700 includes an example variable advertising mailer generator 701, which includes an example variable content generator 702, an example consumer database 704, the example region identifier 706, the example consumer data analyzer/indexer 708, an example regional retailer database 712, and the example retail data analyzer 714. In this example, the variable advertising mailer generator 701 is communicatively coupled to an example data/network interface 716, which may, in turn, be communicatively coupled to the network 104 of FIG. 1.

In operation, the example region identifier 706 defines a region (e.g., a retail zone, an advertising region, an advertising zone, etc.) and/or a size (e.g., dimensions) or shape of the region. This region may be defined based on a retail store location and/or a position relative to a cluster of retail stores, which may be of a same retail chain or a different retail chain. In some examples, the region is defined using a reiterative process that continuously repeats evaluation of predicted response rates of consumers and/or consumer subsets based on reiteratively adjusting defined retail zones, selected consumer subsets and/or determined advertising retailers to be included in the advertising content, for example.

The example region identifier 706 may analyze different locations using map data (e.g., from multiple mapping sources via the data/network interface 716), which may include geographic locations of retail stores, and analyze different locations of the retail stores to define a retail zone of the region. In particular, the example region identifier 706 may repeatedly search for favorable retail zones and/or retail zones by reiteratively moving a center point. In some examples, the center point and/or size of the retail zone may be moved and/or repeatedly adjusted to capture a threshold amount of retail stores and/or consumers (e.g., favorable consumers, consumers likely to respond to the advertising content) in the defined retail zone. In some examples, multiple retail zones are defined based on retail store positioning and/or centering on retail store(s) or a cluster of retail stores, for example, and then a subset of the multiple retail zones may be selected based on favorability of the consumers in the retail zones to advertising, for example. The example region identifier 706 includes a calculator to calculate distances between retailer stores, store and home, and/or center points and boundaries of the zone.

In this example, the example retail data analyzer 714 accesses the regional retailer database 712 to determine relevant retailers and/or products based on the retail zone that is defined by the example region identifier 706. In particular, the relevant retailers and/or products are determined to be included in generated customized marketing content. In particular, the retailers are determined to have a consumer shopping confidence index higher than a defined threshold. In some examples, the relevant retailers and/or products are at least partially based on consumers selected within the defined retail zone. In some examples, the determined relevant retailers are automatically sent offers (e.g., electronic offers) by the example variable advertising mailer generator 701 via the data/network interface 716. In some examples, the retail data analyzer 714 verifies a presence of retailers within or proximate the defined retail zone to ensure that retailers who are not present within or proximate the defined retail zone are excluded from being featured in the custom generated advertising content.

The example consumer data analyzer/indexer 708 of the illustrated example selects or defines a subset (e.g., a demographic subset) of consumers of the defined retail zone based on consumer data accessed from the consumer database 704. In particular, the subset of consumers are selected based on the determined relevant product categories and/or retailers and have a consumer shopping confidence index (e.g., an average consumer shopping confidence index amongst retailers of a retail category) higher than a defined threshold. Alternatively, the subset of consumers may not be determined based on the defined retailers and/or products. In some examples, only the groups with the highest consumer shopping confidence indexes are selected (e.g., the top five average consumer shopping confidence indexes), regardless of determined retailers, for example.

Based on the retail zone defined by the region identifier 706, the relevant retailers determined by the retail data analyzer 714, and the subset of consumers selected by the consumer data analyzer 708, the variable content generator 702 generates focused customized advertising content to be sent to the selected subset of consumers within the retail zone. For example, the variable content generator may select advertising content for the selected retailers to be placed into predefined portions of the advertising content (e.g., portions 502, 504, 602, 604 of the custom variable advertising 500) based on specific consumers and/or the selected subset. In some examples, the variable content generator 702 utilizes codes, which may be appended to household demographic data, to determine demographic characteristics of specific consumers and/or households and/or uses version codes to generate the advertising content by associating creative content with the household demographic data. In some examples, the relevant retailers are sent offers (e.g., electronic offers) for inclusion into customized advertising content that is to be transmitted from the variable advertising mailer generator 701 for production. In some examples, automated/electronic receipt of acceptance of the offers to potential retail advertisers, automatically triggers generation of the customized advertising content.

In some examples, the variable content generator 702 transmits data to a printing/production/distribution facility so that the customized advertising content can be printed on a mailing flyer (e.g., a mailer, shared mail, the custom generated advertising content 500) and/or sent out for distribution. In some examples, the variable content generator 702 is able to define customized advertising content for each individual consumer of the subset of consumers within the defined retail zone.

While an example manner of implementing the example custom advertising generation system 700 is illustrated in FIG. 7, one or more of the elements, processes and/or devices illustrated in FIG. 7 may be combined, divided, re-arranged, omitted, eliminated and/or implemented in any other way to create virtually unlimited dynamically optimized and variable content of advertising up to and including the household level. Further, the example variable advertising content mailer 701, the example variable content generator 702, the example consumer database 704, the example region identifier 706, the example consumer data analyzer/indexer 708, the example regional retailer database 712, the example retailer data analyzer 714, the example data/network interface 716 and/or, more generally, the example custom advertising generation system 700 of FIG. 7 may be implemented by hardware, software, firmware and/or any combination of hardware, software and/or firmware. Thus, for example, any of the example variable advertising mailer generator 701, the example variable content generator 702, the example consumer database 704, the example region identifier 706, the example consumer data analyzer/indexer 708, the example regional retailer database 712, the example retailer data analyzer 714, the example data/network interface 716 and/or, more generally, the example custom advertising generation system 700 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example variable advertising mailer generator 701, the example variable content generator 702, the example consumer database 704, the example region identifier 706, the example consumer data analyzer/indexer 708, the example regional retailer database 712, the example retailer data analyzer 714 and/or the example data/network interface 716 is/are hereby expressly defined to include a tangible computer readable storage device or storage disk such as a memory, a digital versatile disk (DVD), a compact disk (CD), a Blu-ray disk, etc. storing the software and/or firmware. Further still, the example custom advertising generation system 700 of FIG. 7 may include one or more elements, processes and/or devices in addition to, or instead of, those illustrated in FIG. 8, and/or may include more than one of any or all of the illustrated elements, processes and devices.

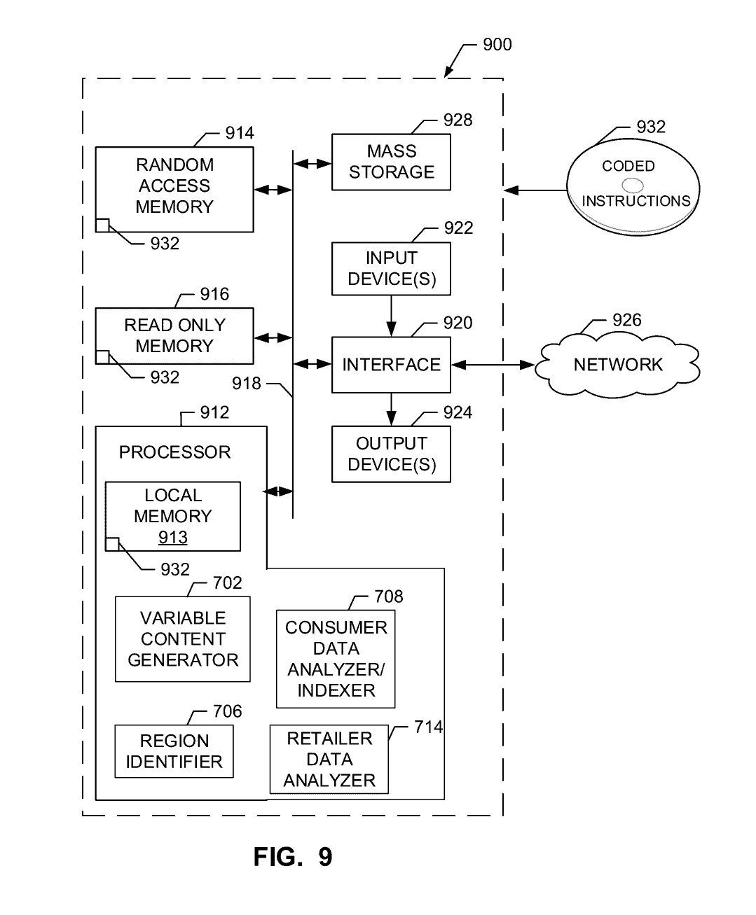

A flowchart representative of example machine readable instructions for implementing the custom advertising generation system 700 of FIG. 7 is shown in FIG. 8. In this example, the machine readable instructions comprise a program for execution by a processor such as the processor 912 shown in the example processor platform 900 discussed below in connection with FIG. 9. The program may be embodied in software stored on a tangible computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowchart illustrated in FIG. 8, many other methods of implementing the example custom advertising generation system 700 may alternatively be used. For example, the order of execution of the blocks may be changed, and/or some of the blocks described may be changed, eliminated, or combined.

As mentioned above, the example processes of FIG. 8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example process of FIG. 8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example method 800 of FIG. 8 includes selecting a region (e.g., one or more state(s), county/counties, metropolitan area(s), city/cities, or portion(s) thereof, etc.) for a focused marketing campaign (block 801). In this example, a retail zone (e.g., the retail zone 204) is to be defined and/or selected for the marketing campaign, in which recipients will receive custom generated advertising content. In some examples, numerous retail zones are to be defined or selected (e.g., simultaneously defined or selected). In some examples, a list of potential retail advertisers is selected and/or provided prior to defining the retail zone.

In some examples, it is determined whether there are current seasonal factors (block 802). For example, an existence of a holiday period, an upcoming holiday period and/or seasonal factors (e.g., fall, winter, summer, back-to-school) may be determined based on calendar/holiday data, for example. In some examples, if there are current seasonal factors (block 802), pertinent retail categories/subject(s) to be advertised are selected based on the current seasonal factors using data as shown above in connection with FIG. 4A, for example (block 804).

For example, if the custom generated content advertising is being planned to be mailed and/or received by consumers in August, retailers that are involved in the pertinent categories will be presented and/or be offered to be presented in the custom generated content advertising. In some examples, a retailer subgroup or retailers may be selected based on the current seasonal factors (e.g., a jacket retailer may be selected in late fall, etc.). In some examples, consumer demographic data along with the current seasonal factors are used to define relevant consumers and/or retailers/products. Once the pertinent retail categories have been selected (block 804) and the process proceeds to block 806. If there are no seasonal factors (block 802), the process proceeds directly to block 806.

The retail zone (e.g., a trade zone, an area of significant population and/or retail activity) is defined (block 806). In particular, a region identifier such as the example region identifier 706 of FIG. 7 may be used to define the retail zone. In this example, the location (e.g., the retail zone center, retail zone centroid for an irregularly-shaped retail zone, etc.) is defined by a location of a major retail store. For example, the retail zone location may be centered relative to a major retail store location and/or centered directly on the major retail store. Alternatively, in some examples, the retail zone is defined based on a cluster of retail stores, which may be of the same retail chain or not. In some examples, the size of the retail zone (e.g., a radius and/or diameter of the retail zone) is defined by a population encompassed by the retail zone, a desired advertising distribution area, a number of consumer households that are deemed relevant based on consumer/demographic information, and/or local economic data (e.g., economic data regarding a local vicinity, economic data of the overall region, etc.).

As mentioned above, the retail zone may be defined using a reiterative process in which numerous parameters (e.g., selected consumers, defined regions, selected retailers or products, etc.) are repeatedly and/or continuously adjusted (block 808) in order to increase overall response rates. In examples where these aforementioned factors are determined using such a reiterative process, an algorithm may utilize map information (e.g., online map data, stored map data, etc.), for example, to repeatedly evaluate different regional locations and/or sizes based on potential consumer responses, consumer subset relevance and/or retail store relevance (e.g., retail store location, retail store type, etc.). In some examples, multiple retail zones are defined (e.g., defined simultaneously). Additionally or alternatively, multiple retail zones are defined in a reiterative process that takes into account the effect of multiple retail zones relative to one another (e.g., whether multiple retail zones will affect one another in terms of overall advertising effectiveness/efficiency, etc.).

Relevant retailers and/or products (e.g., products to be advertised) for the retail zone are determined (block 810). In this example, the relevant retailers and/or products are determined from seasonal data by using a retail data analyzer such as the retail data analyzer 714 that may access or retrieve regional retail information (e.g., information about retailers and/or retailer markets) from a database such as the regional retailer database 712 and/or access retail information from a data/network interface such as the data/network interface 716 to identify potential retailers, for example. In other examples, the relevant retailers may be determined by the retail data analyzer based on predicted responsiveness of consumers (e.g., the consumer subsets 422), which may be quantified by consumer confidence shopping indexes in relationship to the retailers. In some examples, the relevant retailers may be at least partially based on the demographic subsets and/or selected subset of consumers. In some examples, relevant retailers are evaluated by a presence of their retail stores in the defined retail zone (e.g., by a distance from a retail store is from the retail zone, etc.). For example, if a retailer does not have a store within a defined proximity of the retail zone, the retailer may be eliminated from being featured in the custom generated advertising. Such a determination may occur through accessing locational databases and/or mapping data (e.g., a mapping website).

Next, in this example, consumers (e.g., an aggregate list of consumers, an unrefined or unsorted list of consumers/households, etc.) in the defined retail zone are identified and/or received as data, for example (block 812). In some examples, this aggregate list of consumers within the retail zone is determined by parsing and/or querying overall consumer data (e.g., consumer demographic data, a consumer list, and/or a purchased consumer list from a third-party) of the region in which the retail zone is defined. For example, map information/data may be used in conjunction with a list of consumer addresses to identify the consumers in the defined retail zone. In some examples, the consumer data of the retail zone is provided by a consumer database such as the consumer database 704 and/or received from an external server via a data/network interface such as the data/network interface 716 to map/correlate demographic data to the identified consumers.

A subset of consumers from the identified consumers of the retail zone is then selected by querying and/or searching the identified consumers of the retail zone by a consumer data analyzer/indexer such as the consumer data analyzer/indexer 708 of FIG. 7 (block 814). For example, the subset of consumers within the retail zone may be selected from the identified consumers by exhibiting favorable demographic characteristics based on consumer behavior (e.g., survey data). In particular, the survey response data may be used to select favorable demographic subsets (e.g., demographics subsets having consumer shopping confidence indexes above a threshold) by determining households and/or consumers from the overall list of identified consumers within favorable demographic subset categories to receive the advertising materials pertaining to relevant retailers and/or retail categories, for example. In some examples, national survey data results relating demographic subset categories to consumer confidence shopping indexes that correspond to specific retail categories are used to select the consumer subsets within the retail zone. Additionally or alternatively, regional and/or local surveys are used. Additionally or alternatively, retail patterns, common loyalty program memberships, common spending patterns and/or demographics (e.g., commonalities in demographics or spending patterns/behavior) may also be considered.

The example process 800 also includes determining a predicted response rate (block 816). The predicted response rate is based on, for example, the defined retail zone, the selected retailer(s), and features product(s)/service(s), and the selected subset of consumers (the recipients).

Next, it is determined whether to repeat the response rate calculation with adjusted value(s) (block 818). For example, at least a portion of the process 800 may be repeated (e.g., during a reiterative process) to find a combination of selected consumer subsets and/or selected retailers based on the retail zone and/or the relevant retailers to yield a higher (e.g. an optimized) yield for expected response rates, for example. In some examples, the process may repeat itself until a goal overall threshold yield is met (e.g., until a combination of consumers subsets and selected retailers for the custom generated advertising content that yield at least a threshold predicted response rate). If the process is to be repeated (block 818), control returns to block 806 in which the retail zone is defined and the process continues with adjustments to one or more of the defined retail zone, the selected retailer(s), features product(s)/service(s), and the selected subset of consumers (the recipients). An additional predicted response rate is calculated with the updated values (block 816).

If the response rate prediction process is not to be repeated (block 818), the process 800 continues and compares the calculated response rates (block 820). Additionally or alternatively, in some examples, the calculated response rates are compared to a threshold. The example process 800 includes selecting the desired response rate based on the comparison (block 822) The variable advertising content is defined (block 824) using the defined retail zone, the selected retailer(s), and features product(s)/service(s), and the selected subset of consumers (the recipients) associated with the selected consumer shopping confidence index from block 822.

Variable advertising content is then generated by a variable content generator such as the variable content generator 702 (block 826). In this example, the variable advertising content (e.g., the custom variable content advertising 500) is generated based on the consumer subset and the determined relevant retailers. In some examples, the variable content generator determines retailers and/or content that is to be placed onto different portions (e.g., the portions 522, 524) for each of the variable advertising content generated for an individual consumer and/or selected consumer subset. In some examples, once the variable advertising content is generated, the variable advertising content is transmitted to a printer/production facility to be printed and/or distributed. The example process 800 then ends (block 828).

FIG. 9 is a block diagram of an example processor platform 900 capable of executing the instructions of FIG. 8 to implement the custom advertising generation system 700 of FIG. 7. The processor platform 900 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer.

The processor 912 of the illustrated example includes a local memory 913 (e.g., a cache). The example processor 912 also includes the example variable content generator 702, the example region identifier 706, the example consumer data/analyzer indexer 708 and the retailer data analyzer 714. The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIG. 8 may be stored in the mass storage device 928, in the volatile memory 914, in the non-volatile memory 916, and/or on a removable tangible computer readable storage medium such as a CD or DVD.

One example method includes defining a retail zone based on a location of one or more retail stores, identifying a subject to be advertised, and selecting a subset of consumers within the retail zone based on consumer data. The example method also includes generating variable content advertising for the subset of consumers based on the consumer data and the subject to be advertised.

In some examples, identifying at least one of the subset of consumers or the subject to be advertised is based on seasonal data. In some examples, a size of the retail zone is based on one or more of population of the retail zone, the consumer data, retail data or geographical features within or proximate the retail zone. In some examples, defining the retail zone includes defining a zone around a cluster of retail stores. In some examples, the subset of consumers are identified by one or more loyalty programs. Some example methods further include re-defining the retail zone based on the identified relevant products, retailers or updated seasonal information.

In some examples, selecting the subset of consumers includes selecting consumer subsets that exceed a threshold consumer shopping confidence index. In some examples, selecting the subset of consumers includes predicting a response rate and comparing the response rate to a threshold. In some examples, one or more of the retail zone, a subject of the plurality of subjects to be advertised, or the selected consumers is adjusted until the predicted response rate exceeds the threshold. In some examples, one or more of the retail zone, the subject to be advertised, or the selected consumers is adjusted until a highest consumer shopping confidence index score of the adjustments is determined for inclusion.

An example tangible machine readable medium has instructions stored thereon, which when executed, cause a processor to define, based on locational data, a zone based on the location of one or more retail stores, select retailers from a list of retailers based on the defined zone and seasonal data, generate, based on at least one of the consumer data or the retailer data, customized marketing content for each consumer of the subset, and transmit data pertaining to the customized marketing content to a printer or a printer location.

In some examples, a processor is further caused to update the zone based on the consumer data or seasonal information. In some examples, the defined zone or the selected subset of consumers are determined based on seasonal data. In some examples, the subset of consumers are at least partially selected by loyalty membership information. In some examples, the customized marketing content includes a flyer with individualized advertisements for each consumer. In some examples, the zone is defined by centering a round-shaped area proximate locations of one or more retail stores and defining the diameter of the round area based on one or more of the consumer data, geographic data, or retail data.

In some examples, the customized marketing content is defined by a subject to be advertised. In some examples, the subset of consumers are selected by comparing a predicted response rate to a threshold. In some examples, a processor is further caused to adjust one or more of the retail zone, the selected retailers, or the selected consumers until the predicted response rate exceeds the threshold. In some examples, a processor is further caused to adjust one or more of the retail zone, the selected retailers, or the selected consumers until a highest predicted response rate of the adjustments is determined.

One example method includes defining a retail zone based on a location of one or more retail stores, identifying a subject to be advertised, and selecting a subset of consumers within the retail zone based on consumer data. The example method also includes generating variable content advertising for the subset of consumers based on the consumer data and the subject to be advertised.

In some examples, identifying at least one of the subset of consumers or the subject to be advertised is based on seasonal data. In some examples, a size of the retail zone is based on one or more of population of the retail zone, the consumer data, retail data or geographical features within or proximate the retail zone. In some examples, defining the retail zone includes defining a zone around a cluster of retail stores. In some examples, the subset of consumers are identified by one or more loyalty programs. In some examples, the example method further includes re-defining the retail zone based on the identified relevant products, retailers or updated seasonal information. In some examples, selecting the subset of consumers includes selecting consumer subsets that exceed a threshold consumer shopping confidence index.

In some examples, selecting the subset of consumers includes predicting a response rate and comparing the response rate to a threshold. In some examples, one or more of the retail zone, the subject to be advertised, or the selected consumers is adjusted until the predicted response rate exceeds the threshold. In some examples, one or more of the retail zone, the subject to be advertised, or the selected consumers is adjusted until a highest consumer confidence index of the adjustments is determined.

An example tangible machine readable medium having instructions stored thereon, which when executed, cause a processor to define, based on locational data, a zone based on the location of one or more retail stores, select retailers from a list of retailers based on the defined zone and seasonal data, select a subset of consumers within the zone based on at least one of consumer data or retailer data, generate, based on at least one of the consumer data or the retailer data, customized marketing content for each consumer of the subset, and transmit data pertaining to the customized marketing content to a printer or a printer location.

In some examples, a processor is further caused to update the zone based on the consumer data or seasonal information. In some examples, the defined zone or the selected subset of consumers are determined based on seasonal data. In some examples, the subset of consumers are at least partially selected by loyalty membership information. In some examples, the customized marketing content includes a flyer with individualized advertisements for each consumer. In some examples, the zone is defined by centering a round-shaped area proximate locations of one or more retail stores and defining a diameter of the round area based on one or more of the consumer data, geographic data, or retail data.

In some examples, the customized marketing content is defined by a subject to be advertised. In some examples, the subset of consumers are selected by comparing a predicted response rate to a threshold. In some examples, a processor is further caused to adjust one or more of the retail zone, the selected retailers, or the selected consumers until the predicted response rate exceeds the threshold. In some examples, a processor is further caused to adjust one or more of the retail zone, the selected retailers, or the selected consumers until a highest predicted response rate of the adjustments is determined.

An example customized variable content advertising includes a printed substrate and advertising sections defined on the substrate with advertising content of advertisers. The advertising sections are defined by a determined retail zone based on a location of one or more retail stores, an identified subject to be advertised, and a selected subset of consumers within the retail zone based on consumer data. In some examples, the printed substrate includes three to six advertising sections. In some examples, the printed substrate includes a single folded mailer. In some examples, the printed substrate includes separable designated advertising sections.

An example system for generating customized variable content advertising includes means for identifying a retail zone and a subject to be advertised, and means for selecting a subset of consumers within the retail zone based on consumer data. The example system also includes means for generating the customized variable content advertisement based on the identified retail zone, the identified subject, and the selected subset of consumers. In some examples, the means for identifying the retail zone and subject to be advertised utilizes map data.

One example method to reduce the processing resources needed to develop variable content advertising, the method includes defining a retail zone based on a location of one or more retail stores and excluding retail zones outside of the defined area and identifying a subject to be advertised. The example method also includes using a processor to analyze candidate recipients of the advertising to exclude a first plurality of candidate recipients based on the retail zone, exclude a second plurality of candidate recipients based on first consumer data, exclude a third plurality of candidate recipients based on the subject to be advertised, and select a fourth plurality of candidate recipients. The fourth plurality is to not overlap with the first, second, or third pluralities. The example method also includes using the processor to analyze the fourth plurality of candidate recipients and select a subset of recipients of the fourth plurality based on second consumer data and the subject to be advertised. The example method also includes generating the variable content advertising for the subset of recipients. In some examples, the second consumer data is based on seasonal data. In some examples, the second consumer data includes loyalty program data. Some examples also include re-defining the retail zone based on the subject to be advertised. In some examples, the second consumer data includes is based on a consumer shopping confidence index.

An example method includes defining a retail zone based on a location of one or more retail stores, identifying a plurality of subjects to be advertised, selecting a subset of consumers within the retail zone based on consumer data, and generating variable content advertising for the subset of consumers based on the consumer data and the plurality of subjects to be advertised. The example method also includes printing a segmented advertisement brochure based on the generated variable content advertising, where the advertisement brochure includes a plurality of segment portions, where a first segment portion of the plurality of segment portions includes a first subject of the plurality of subjects to be advertised and a second segment portion of the plurality of segment portions includes a second subject of the plurality of subjects to be advertised, and where the second subject is distinct from the first subject.

In some examples, identifying at least one of the subset of consumers or the plurality of subjects to be advertised is based on seasonal data. In some examples, a size of the retail zone is based on one or more of population of the retail zone, the consumer data, retail data, or geographical features within or proximate the retail zone. In some examples, defining the retail zone includes defining a zone around a cluster of retail stores. In some examples, defining the retail zone includes utilizing a heat map of the cluster of retail stores. In some examples, the subset of consumers are identified by one or more loyalty program. In some examples, the method also includes including re-defining the retail zone based on one or more of the identified plurality of subjects, retailers, or updated seasonal information.

In some examples, selecting the subset of consumers includes selecting consumer subsets that exceed a threshold consumer shopping confidence index. In some examples, selecting the subset of consumers includes predicting a response rate and comparing the response rate to a threshold. In some examples, one or more of the retail zone, the subject to be advertised, or the selected consumers is adjusted until the predicted response rate exceeds the threshold. In some examples, one or more of the retail zone, the subject to be advertised, or the selected consumers is adjusted until a highest consumer confidence index of the adjustments is determined. In some examples, the method also includes transmitting at least one proposal to at least one retailer based on the identified plurality of subjects to be advertised prior to generating the variable content advertising. The example method also includes identifying a conflict exists between two or more retailers.

An example tangible machine readable medium has instructions stored thereon, which when executed, cause a processor to define a zone based on a location of one or more retail stores, select retailers from a list of retailers based on the defined zone and seasonal data, and select a subset of consumers within the zone based on at least one of consumer data or retailer data. The example tangible machine readable medium also causes the processor to generate, based on at least one of the consumer data or the retailer data, customized marketing content for each consumer of the subset, where the customized marketing content defines a plurality of segment portions, where a first segment portion of the plurality of the segment portions includes a first subject of a plurality of subjects to be advertised and a second segment portion of the plurality of segment portions includes a second subject of the plurality of subjects to be advertised, and where the second subject is distinct from the first subject. The example tangible machine readable medium also causes the processor to transmit data pertaining to the customized marketing content to a printer or a printer location.

In some examples, a processor is further caused to update the zone based on the consumer data or seasonal information. In some examples, the defined zone or the selected subset of consumers is determined based on seasonal data. In some examples, the subset of consumers is at least partially selected by loyalty membership information. In some examples, the customized marketing content includes a flyer with individualized advertisements for each consumer. In some examples, the zone is defined by centering a round-shaped area proximate locations of one or more retail stores and defining a diameter of the round area based on one or more of the consumer data, geographic data, a retail heat map or retail data. In some examples, the customized marketing content is defined by a subject to be advertised. In some examples, the subset of consumers are selected by comparing a predicted response rate to a threshold. In some examples, a processor is further caused to adjust one or more of the zone, the selected retailers, or the selected consumers until the predicted response rate exceeds the threshold. In some examples, a processor is further caused to adjust one or more of the zone, the selected retailers, or the selected consumers until a highest predicted response rate of adjustments is determined.

An example customized variable content advertising includes a printed substrate. The example customized variable content advertising also includes segmented advertising sections defined on the substrate with advertising content of advertisers, the advertising sections defined by a determined retail zone based on a location of one or more retail stores, a plurality of identified subjects to be advertised in the designated advertising sections, each of the plurality of identified subjects having a distinct retail category from others of the plurality of identified subjects, and a selected subset of consumers within the retail zone based on consumer data.

In some examples, the printed substrate includes three to six advertising sections. In some examples, the printed substrate includes a single folded mailer. In some examples, the segmented advertising sections are separable from the printed substrate. In some examples, the advertising segments are coupled to the substrate via a releasable adhesive.

An example system for generating customized variable content advertising includes means for identifying a retail zone and a plurality of subjects to be advertised and means for selecting a subset of consumers within the retail zone based on consumer data. The example system for generating customized variable content advertising also includes means for generating a segmented advertisement printout based on the identified retail zone, the identified plurality of subjects, and the selected subset of consumers, where the segmented advertisement printout includes a plurality of segment portions, where a first segment portion of the plurality of segment portions includes a first subject of the plurality of subjects to be advertised and a second segment portion of the plurality of segment portions includes a second subject of the plurality of subjects to be advertised, and where the second subject is distinct from the first subject.

In some examples, the means for identifying the retail zone centers a region defined by a retail store or a cluster of retail stores. In some examples, the means for identifying the retail zone and subject to be advertised utilizes map data.

An example method to reduce processing resources needed to develop variable content advertising includes defining a retail zone based on a location of one or more retail stores and excluding retail zones outside of the retail zone, and identifying a plurality of subjects to be advertised. The example method also includes using a processor to analyze candidate recipients of the variable content advertising to exclude a first plurality of candidate recipients based on the retail zone, exclude a second plurality of candidate recipients based on first consumer data, exclude a third plurality of candidate recipients based on the plurality of subjects to be advertised, and select a fourth plurality of candidate recipients, where the fourth plurality do not overlap with the first, second, or third pluralities. The example method also includes using the processor to analyze the fourth plurality of candidate recipients and select a subset of recipients of the fourth plurality based on second consumer data and the plurality of subjects to be advertised. The example method also includes generating a segmented advertisement brochure for the subset of recipients, where the advertisement brochure includes a plurality of segment portions, a first segment portion of the plurality of segment portions includes a first subject of the plurality of subjects to be advertised and a second segment portion of the plurality of segment portions includes a second subject of the plurality of subjects to be advertised, where the second subject is distinct from the first subject.

In some examples, the second consumer data is based on seasonal data. In some examples, the second consumer data includes loyalty program data. In some examples, the method further includes re-defining the retail zone based on the plurality of subjects to be advertised. In some examples, the second consumer data includes is based on a consumer shopping confidence index.

From the foregoing, it will be appreciated that the above disclosed examples allow generation of highly-effective customized advertising that is targeted to select consumers and/or consumer groups within a determined retail zone. The example systems and methods disclosed herein have many advantageous technical effects. For example, the examples disclosed herein reduce the amount of potential or candidate advertisers and/or advertisements that are analyzed by a processor for inclusion in a mailer. This reduces processing time and the resources needed to produce an effective customized advertisement. Furthermore, because the mailers developed with the disclosed systems and methods include less, but more relevant, advertisements, which may include less images and copy and therefore, less data, the computers involved can operate more quickly to produce a resulting product of higher quality than traditional methods.

In addition, the disclosed systems and methods reduce the size and amount of direct mail, which enables printers to use less resources such as, for example, ink and paper. The disclosed systems and methods also enable the postal service to operate more expediently and deliver the customized mailers more quickly as there is less bulk (and junk) mail to deliver.

The output of these disclosed examples is a transformed mailer. In other words, implementation of the examples disclosed herein transforms a traditional bulk-mailed advertising circular into a targeted mailer that a recipient finds more meaningfully addresses his or her needs and/or desires and is less likely to be discarded without consideration. This enhances the value of the advertisement to both the advertiser and the recipient and reduces wasteful excesses prevalent in the industry.

This application claims the benefit under 35 U.S.C. §119(e) to U.S. Provisional Application 62/197,445 titled “CUSTOMIZED VARIABLE CONTENT MARKETING DISTRIBUTION,” filed Jul. 27, 2015, which is incorporated herein by this reference in its entirety.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent. While the examples disclosed herein are directed towards printed media and mail distribution, the examples disclosed herein may be applied to any appropriate media or form of distribution.

What is claimed is:

1. A method comprising:
defining a retail zone based on a location of one or more retail stores;
identifying a plurality of subjects to be advertised;
selecting a subset of consumers within the retail zone based on consumer data; and
generating variable content advertising for the subset of consumers based on the consumer data and the plurality of subjects to be advertised; and
printing a segmented advertisement brochure based on the generated variable content advertising, the advertisement brochure including a plurality of segment portions, wherein a first segment portion of the plurality of segment portions includes a first subject of the plurality of subjects to be advertised and a second segment portion of the plurality of segment portions includes a second subject of the plurality of subjects to be advertised, the second subject distinct from the first subject.

2. The method as defined in claim 1, wherein identifying at least one of the subset of consumers or the plurality of subjects to be advertised is based on seasonal data.

3. The method as defined in claim 1, wherein a size of the retail zone is based on one or more of a population of the retail zone, the consumer data, retail data, or geographical features within or proximate the retail zone.

4. The method as defined in claim 1, wherein defining the retail zone includes defining a zone around a cluster of retail stores.

5. The method as defined in claim 4, wherein defining the retail zone includes utilizing a heat map of the cluster of retail stores.

6. The method as defined in claim 1, wherein the subset of consumers are identified by one or more loyalty programs.

7. The method as defined in claim 1, further including re-defining the retail zone based on one or more of the identified plurality of subjects, retailers, or updated seasonal information.

8. The method as defined in claim 1, wherein selecting the subset of consumers includes selecting consumer subsets that exceed a threshold consumer shopping confidence index.

9. The method as defined in claim 1, wherein selecting the subset of consumers includes predicting a response rate and comparing the response rate to a threshold.

10. The method as defined in claim 9, wherein one or more of the retail zone, a subject of the plurality of subjects to be advertised, or the selected consumers is adjusted until the predicted response rate exceeds the threshold.

11. The method as defined in claim 1, wherein one or more of the retail zone, the subject to be advertised, or the selected consumers is adjusted until a highest consumer confidence index of the adjustments is determined.

12. The method as defined in claim 1, further including transmitting at least one proposal to at least one retailer based on the identified plurality of subjects to be advertised prior to generating the variable content advertising.

13. The method as defined in claim 12, further including identifying a conflict exists between two or more retailers.

14. A tangible machine readable medium having instructions stored thereon, which when executed, cause a processor to:
define a zone based on a location of one or more retail stores;
select retailers from a list of retailers based on the defined zone and seasonal data;
select a subset of consumers within the zone based on at least one of consumer data or retailer data;
generate, based on at least one of the consumer data or the retailer data, customized marketing content for each consumer of the subset, the customized marketing content defining a plurality of segment portions, wherein a first segment portion of the plurality of segment portions includes a first subject of a plurality of subjects to be advertised and a second segment portion of the plurality of segment portions includes a second subject of the plurality of subjects to be advertised, the second subject distinct from the first subject; and
transmit data pertaining to the customized marketing content to a printer or a printer location.

15. The machine readable medium as defined in claim 14, wherein the customized marketing content includes a flyer with individualized advertisements for each consumer.

16. The machine readable medium as defined in claim 14, wherein the zone is defined by centering a round-shaped area proximate locations of one or more retail stores and defining a diameter of the round area based on one or more of the consumer data, geographic data, a retail heat map, or retail data.

17. The machine readable medium as defined in claim 14, wherein the customized marketing content is defined by a subject to be advertised.

18. Customized variable content advertising comprising:
a printed substrate; and
segmented advertising sections defined on the substrate with advertising content of advertisers, the segmented advertising sections defined by:
a determined retail zone based on a location of one or more retail stores,
a plurality of identified subjects to be advertised in the segmented advertising sections, each of the plurality of identified subjects having a distinct retail category from others of the plurality of identified subjects, and
a selected subset of consumers within the retail zone based on consumer data.

19. The customized variable content advertising as defined in claim 18, wherein the printed substrate includes a single folded mailer.

20. The customized variable content advertising as defined in claim 18, wherein the segmented advertising sections are separable from the printed substrate.

21. The customized variable content advertising as defined in claim 18, wherein the advertising segments are coupled to the substrate via a releasable adhesive.

22. A system for generating customized variable content advertising comprising:
means for identifying a retail zone and a plurality of subjects to be advertised;
means for selecting a subset of consumers within the retail zone based on consumer data; and
means for generating a segmented advertisement printout based on the identified retail zone, the identified plurality of subjects, and the selected subset of consumers, the segmented advertisement printout including a plurality of segment portions, wherein a first segment portion of the plurality of segment portions includes a first subject of the plurality of subjects to be advertised and a second segment portion of the plurality of segment portions includes a second subject of the plurality of subjects to be advertised, the second subject distinct from the first subject.

23. A method to reduce processing resources needed to develop variable content advertising, the method comprising:
defining a retail zone based on a location of one or more retail stores and excluding retail zones outside of the retail zone;
identifying a plurality of subjects to be advertised;
using a processor to analyze candidate recipients of the variable content advertising to exclude a first plurality of candidate recipients based on the retail zone, exclude a second plurality of candidate recipients based on first consumer data, exclude a third plurality of candidate recipients based on the plurality of subjects to be advertised, and select a fourth plurality of candidate recipients, the fourth plurality not overlapping with the first, second, or third pluralities;
using the processor to analyze the fourth plurality of candidate recipients and select a subset of recipients of the fourth plurality based on second consumer data and the plurality of subjects to be advertised; and
generating a segmented advertisement brochure for the subset of recipients, the advertisement brochure including a plurality of segment portions, wherein a first segment portion of the plurality of segment portions includes a first subject of the plurality of subjects to be advertised and a second segment portion of the plurality of segment portions includes a second subject of the plurality of subjects to be advertised, the second subject distinct from the first subject.
